(19) United States
(12) Patent Application Publication
(10) Pub. No.: US 2013/0080501 A1
(43) Pub. Date: Mar. 28, 2013

(54) METHOD FOR TRANSMITTING REAL-TIME VIDEO DATA OVER NETWORK

(71) Applicants: Jiangtao Wen, Shenzhen (CN); Chuan Chen, Shenzhen (CN); Zhong Bao, Shenzhen (CN)

(72) Inventors: Jiangtao Wen, Shenzhen (CN); Chuan Chen, Shenzhen (CN); Zhong Bao, Shenzhen (CN)

(21) Appl. No.: 13/240,265

(22) Filed: Sep. 22, 2011

(51) Int. Cl. G06F 15/16

(52) U.S. Cl. 709/203

(57) ABSTRACT

A method for transmitting real-time video data over a network involves a video source, a central server and a Web browser and comprises the following steps that: an applet is embedded into the Web browser to establish a peer-to-peer connection between the central server and the video source using UDP protocol. After receiving the video data transmitted using UDP protocol, the applet converts the received video data into TCP-based data to enable the various TCP-using video players built in the browser to play videos; and the applet converts client information from a TCP protocol format to a UDP protocol format and then sends the converted information directly to the video source.

### TECHNICAL FIELD OF THE INVENTION

The present invention relates to a video transmission technology which is mainly applied to displaying the real-time video captured or stored by a camera in a browser of the Internet or to any occasion where data transmission is carried out in a local area network or wide area network.

### BACKGROUND OF THE INVENTION

UDP and TCP are the most common protocols used in a network transmission layer. Some applications on the Internet such as Web application are based on TCP while other applications such as multimedia transmission and VOIP are generally based on UDP. In order to realize firewall traversal, UDP is generally used in network applications; however, it is difficult to use UDP in the TCP-using Web application, which also explains why most of multimedia applications (e.g. Google Talk, Skype, QQ) capable of traversing firewalls use an independent application program.

Currently, the overwhelming majority of Web-based multimedia such as Youku and Youtube adopt TCP transmission. Such applications adopt a central server distribution mode, that is, all multimedia data is forwarded by a server. This mode which requires an extremely high network bandwidth and a great number of forwarding servers will confront a bottleneck in the operation capability of the servers and the network bandwidth when there are a great many multimedia sources and visitors. P2P technology is an effective method for eliminating the bottleneck in network bandwidth and operation capacity. Some P2P-using multimedia applications such as PPStream, Funshion and PPLive need to download a piece of dedicated software or a plugin of the IE to realize P2P, which is unfavorable for the platform crossing of an application program or even disables the crossing of browsers, and as a consequence, the use of such multimedia applications is severely limited.

### SUMMARY OF THE INVENTION

The present invention aims to provide a method for transmitting real-time video data over a network to address the problems of firewall traversal, P2P real-time video transmission, Web play, browser crossing and operating system crossing.

In order to realize the technical purposes above, the technical solution of the present invention is as follows: a method for transmitting real-time video data over a network involves a video source, a central server and a Web browser and comprises the following steps that: an applet is embedded into the Web browser to establish a peer-to-peer connection between the central server and the video source using UDP protocol; after receiving the video data transmitted using UDP protocol, the applet converts the received video data into TCP-based data to enable the various TCP-using video players built in the browser to play videos; and the applet converts client information from a TCP protocol format to a UDP protocol format and then sends the converted information directly to the video source.

Preferably, the applet is stored on the server of the browser and is downloaded to a client when the Web server is accessed.

Preferably, the applet is a cross-operating system cross-browser applet of Java Applet.

As an automatic firewall traversal is achieved by the present invention, the difficulty in network configuration is greatly lowered, and a real ‘zero configuration’ is realized for the network. Owing to the achievement of P2P, no high-performance high-bandwidth network server is needed, thus decreasing operation cost. Due to the use of Web display mode, the user interface is friendlier and more convenient. Operating systems including Windows, Linux and OSX and browsers including IE, Firefox and Chrome and the like can be crossed more conveniently as there is no need to install a piece of dedicated software.

### BRIEF DESCRIPTION OF THE DRAWING

FIG. 1 is a block diagram illustrating the principle of the present invention.

### DETAILED DESCRIPTION OF THE INVENTION

The invention is described below in detail by reference to accompanying drawings in combination with specific embodiments.

The prior art, which is capable of achieving firewall traversal for real-time videos and P2P such as Google Talk and QQ client software, is, however, incapable of achieving Web play, requiring a different piece of software to be developed for a different operating system. By realizing P2P and firewall traversal on Web application, the technology provided herein can be run on different browsers and operating systems without requiring the independent development of an application for a specific operating system and thus has excellent cross-platform capability.

Video websites such as Youtube and Youku, which are Web-based video applications with excellent platform-crossing capability, forward videos via servers but not through P2P transmission and are therefore free from firewall traversal but, on the other hand, have remarkably high requirements on the operation capability of servers and network bandwidth. As the technology provided herein adopts firewall traversal and P2P, videos of large data size are not forwarded by servers, thus significantly lowering the pressure as well as the operation cost of the servers. In conclusion, the technology provided herein synchronously addresses the problems existing in the transmission and play of real-time video over the Internet and enables real-time videos to be transmitted and played more simply and effectively.

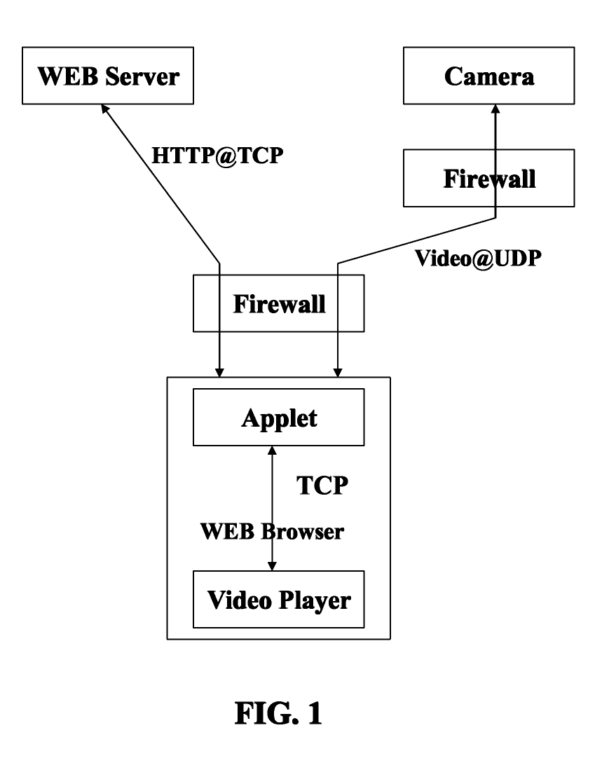

As shown in FIG. 1, by using a cross-operating system cross-browser Applet such as Java Applet, the technology provided herein embeds, into a browser, a specifically-developed applet to establish a peer-to-peer connection between a central server and a video source (camera) using UDP protocol, thereby breaking through the restriction that a client can only communicate with the original server in Web application. After receiving the video data transmitted using UDP, the applet converts the received video data to TCP-based data so that the various TCP-based video players built in the browser can play videos. Client information is also converted from a TCP format to a UDP format via the applet and is then directly sent to the video source.

It should be understood that although being realized through Java applet technology, the present invention can also be realized by any other browser plug-in but not limited to Java applet.

The technology provided herein is realized by a set of software systems, including the firewall traversal and video/audio transmission software installed on the video source (camera) and the user management and firewall traversal software as well as the browser server and the dynamic browser installed on the server, wherein the applet of the browser is located on the browser server and is downloaded to the client of a user when the user accesses the browser. No any other software except an environment for the running of the applet is needed at the client of the browser.

The above-described embodiments are only preferred ones of the invention and are not to be construed as limiting the invention, and any modification, improvement or equivalent devised without departing from the spirit and scope of the invention belongs to the protection scope of the invention.

What is claimed is:

1. A method for transmitting real-time video data over a network, wherein the method involves a video source, a central server and a Web browser and comprises the following steps that: an applet is embedded into the Web browser to establish a peer-to-peer connection between the central server and the video source using UDP protocol; after receiving the video data transmitted using UDP protocol, the applet converts the received video data into TCP-based data to enable the various TCP-using video players built in the browser to play videos; and the applet converts client information from a TCP protocol format to a UDP protocol format and then sends the converted information directly to the video source.

2. The method according to claim 1, wherein the applet is stored on the server of the browser and is downloaded to a client when the Web server is accessed.

3. The method according to claim 1, wherein the applet is a cross-operating system cross-browser applet of Java Applet.
